(19) United States
(12) Patent Application Publication
(10) Pub. No.: US 2014/0051548 A1
(43) Pub. Date: Feb. 20, 2014

(54) BICYCLE DRIVE UNIT

(71) Applicant: Shimano Inc., Osaka (JP)

(72) Inventors: Tetsuya HINO, Osaka (JP); Yusuke NISHIKAWA, Osaka (JP)

(21) Appl. No.: 13/911,718

(22) Filed: Jun. 6, 2013

(30) Foreign Application Priority Data
Aug. 17, 2012 (JP) 2012-180776

(51) Int. Cl. B62M 6/50

(52) U.S. Cl. CPC B62M 6/50
USPC 477/15

(57) ABSTRACT

A bicycle drive unit basically includes a motor and a crank axle torsion sensor unit. The motor has a crank axle receiving hole that is arranged for installing a crank axle. The crank axle torsion sensor unit is at least partially disposed inside of the crank axle receiving hole in between the motor and the crank axle.

### CROSS-REFERENCE TO RELATED APPLICATIONS

This application claims priority under 35 U.S.C. §119 to Japanese Patent Application No. 2012-180776, filed Aug. 17, 2012. The entire disclosure of Japanese Patent Application No. 2012-180776 is hereby incorporated herein by reference.

### BACKGROUND

1. Field of the Invention

This invention generally relates to a bicycle drive unit for an electrically assisted bicycle which uses a motor output as assisting power and that has a transmission mechanism.

2. Background Information

An electrically assisted bicycle is disclosed in Japanese Laid-Open Patent Application No. 2011-207362 that uses a motor output as assisting power. In the electrically assisted bicycle according to patent application, after a pedaling force which is inputted by the pedals is transmitted and the transmitted drive force is combined with a drive force from the motor, the combined drive force is transmitted to the rear wheel, thereby causing the rear wheel to rotate.

### SUMMARY

For the bicycle drive unit in the above mentioned patent application, iii order to determine the drive force of the motor, the pedaling force needs to be measured by a torque sensor arranged on the crank axle. Consequently, the bicycle drive unit has the crank axle and the motor output shaft formed as separate shafts, so that the bicycle drive unit has a long and bulky casing. As a result, the degree of freedom for the design of the bicycle decreases, while the weight increases. This is undesirable.

The present invention was conceived in view of the problem previously described. One object of the present invention is to provide a bicycle drive unit that shares the motor for assisted riding the bicycle and that is lighter and more compact.

In order to achieve the above mentioned object, a bicycle drive unit is provided that basically comprises a motor and a crank axle torsion sensor unit. The motor has a crank axle receiving hole that is arranged for installing a crank axle. The crank axle torsion sensor unit is at least partially disposed inside of the crank axle receiving hole in between the motor and the crank axle.

As a result, the crank axle can be set through the hole of the motor, and the sensor unit can be arranged inside of the hole of the motor, so that the bicycle drive unit becomes lighter and more compact.

In addition, the crank axle receiving hole may be arranged in the rotating center portion of the motor. Also, the rotational axis of the crank axle and the rotational axis of the motor may be arranged coaxially. As a result, the internal mechanism of the motor can be simplified, so that the bicycle drive unit can be made even lighter and more compact.

In addition, the bicycle drive unit may further have a power transmission unit for transmitting the rotating force of the motor and the rotating force of the crank axle. As a result, the assisting function can be realized by the motor.

In addition, the bicycle drive unit may further have a transmission mechanism, which is arranged on the transmission path between the crank axle and the power transmission unit and allows selection from plural gear ratios, so that high efficiency assisting driving can be carried out by the motor.

Furthermore, the sensor unit has a first connecting part connected to the crank axle and a second connecting part that transmits the rotating force to the power transmission unit. Here, the first connecting part and the second connecting part may be arranged separate from each other. As a result, the sensor unit can make a high-precision detection of the torque applied to the crank axle.

In addition, the sensor unit may have a hollow member, which has a first connecting part and a second connecting part and allows the crank axle to be arranged there, and a strain sensor that detects the strain of the hollow member. As a result, the new sensor unit can be installed with respect to the existing crank axle.

In addition, the strain sensor may be a magnetostrictive sensor. The magnetostrictive sensor may have a magnetostrictive element arranged on the hollow member and a coil arranged in the periphery of the magnetostrictive element. As a result, the strain sensor can detect the torsion applied on the crank axle.

Furthermore, the bicycle drive unit may also have a crank axle. As a result, the pedaling force of the rider can be transmitted to the sensor unit.

In addition, the power transmission unit may have a sprocket connecting part connected to the sprocket. As a result, the output of the power transmission unit can be transmitted to the rear hub, etc.

Furthermore, the rotating force of the motor can be transmitted via a one-way clutch to the power transmission unit. As a result, the rotating force of the crank axle can be prevented from being transmitted to the motor.

In addition, the bicycle drive unit may also have a reduction gear unit so that the rotating force of the motor can be transmitted via, the reduction gear unit to the power transmission unit. As a result, the speed reduction for the output of the motor can be achieved, and then the speed reduction can be transmitted to the power transmission unit, so that a power transmission unit that allows for a highly efficient operation of the motor can be realized.

Furthermore, the bicycle drive unit may also have a reduction gear unit so that the rotating force of the motor is input into the reduction gear unit and the output of the reduction gear unit is transmitted via the one-way clutch to the power transmission unit. As a result, the rotating force of the crank axle can be prevented from being transmitted to the motor; at the same time, a highly efficient operation of the motor can be ensured.

In addition, the motor may be an outer rotor-type motor. The motor may be an inner rotor-type motor as well.

Accordingly the drive unit of the present disclosure includes a motor for assisted riding of the bicycle, which is arranged such that a lighter and more compact drive unit can be realized.

### BRIEF DESCRIPTION OF THE DRAWINGS

Referring now to the attached drawings which form a part of this original disclosure:

FIG. 1 is a simplified right side elevational view of a drive train of an electrically assisted bicycle that is equipped with a drive unit in accordance with a first embodiment;

FIG. 2 is a cross-sectional view illustrating the drive unit according to the first embodiment;

FIG. 3 is a simplified right side elevational view illustrating a drive train of an electrically assisted bicycle having a drive unit in accordance with a second embodiment or a third embodiment;

FIG. 4 is a vertical cross-sectional view illustrating the drive unit according to the second embodiment; and

FIG. 5 is a vertical cross-sectional view illustrating the drive unit according to the third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

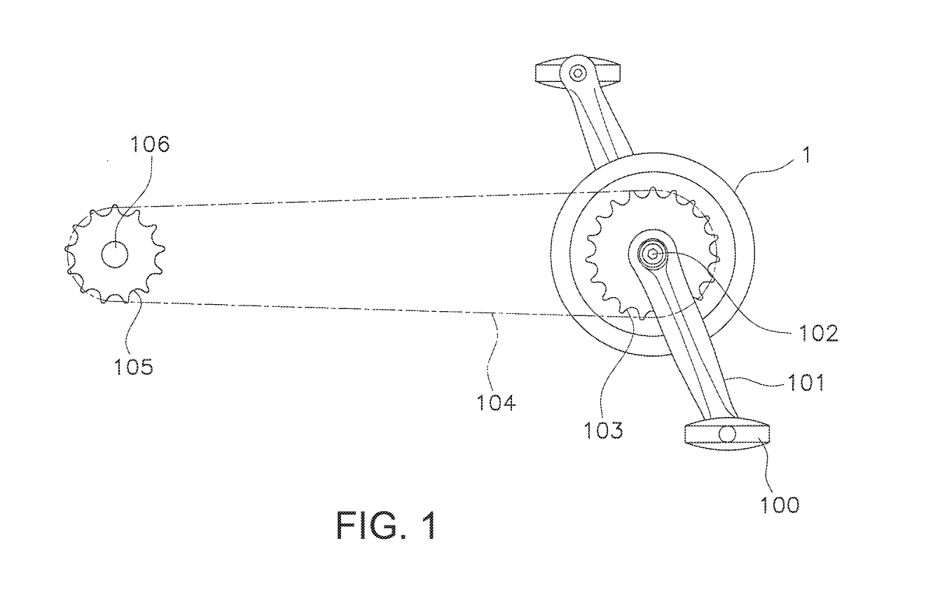

Referring initially to FIG. 1, a right side elevational view of a drive train of an electrically assisted bicycle is illustrated that includes a drive unit 1 in accordance with a first embodiment. Basically, the drive train of the electrically assisted bicycle includes a pair of pedals 100, a pair of crank arms 101, a crank axle 102, a front sprocket 103, a chain 104 and a rear sprocket 105. The pedals 100 are rotatably mounted to the free ends of the crank arms 101, respectively. The inner ends of the crank arms 101 are fixed to opposite ends of the crank axle 102, respectively. The front sprocket 103 is non-rotatably mounted on the crank axle 102. The rear sprocket 105 is mounted non-rotatably mounted on a rear hub axle 106 of a rear wheel.

Basically, the drive train of the electrically assisted bicycle operates as follows: a pedaling force acting on the pedals 100 is transmitted to a rear hub member rotatably disposed around the rear hub axle 106 of the rear wheel via the chain 104. In other words, the drive train has the following drive path: the crank arms 101 the crank axle 102→the drive unit 1→the front sprocket 103→the chain 104→the rear sprocket 105. Thus, in this arrangement, the electrically assisted bicycle combines the motor output as assisting power to assist a rider in riding the bicycle.

The electrically assisted bicycle detects the force corresponding to the torque acting on the crank axle 102 by a crank axle torsion sensor unit to be explained later. In this electrically assisted bicycle, when the detected value is over the preset level, the motor is turned on to generate a torque as the assisting power corresponding to the pedaling force. The drive unit 1 includes an assisting motor 120. The drive unit 1 is usually arranged near a connecting part between a lower end portion of a seat tube of the bicycle frame and a rear end portion of a down tube of the bicycle frame. A battery is arranged along the rear carrier, the down tube or the seat tube for supplying a driving power to the motor 120.

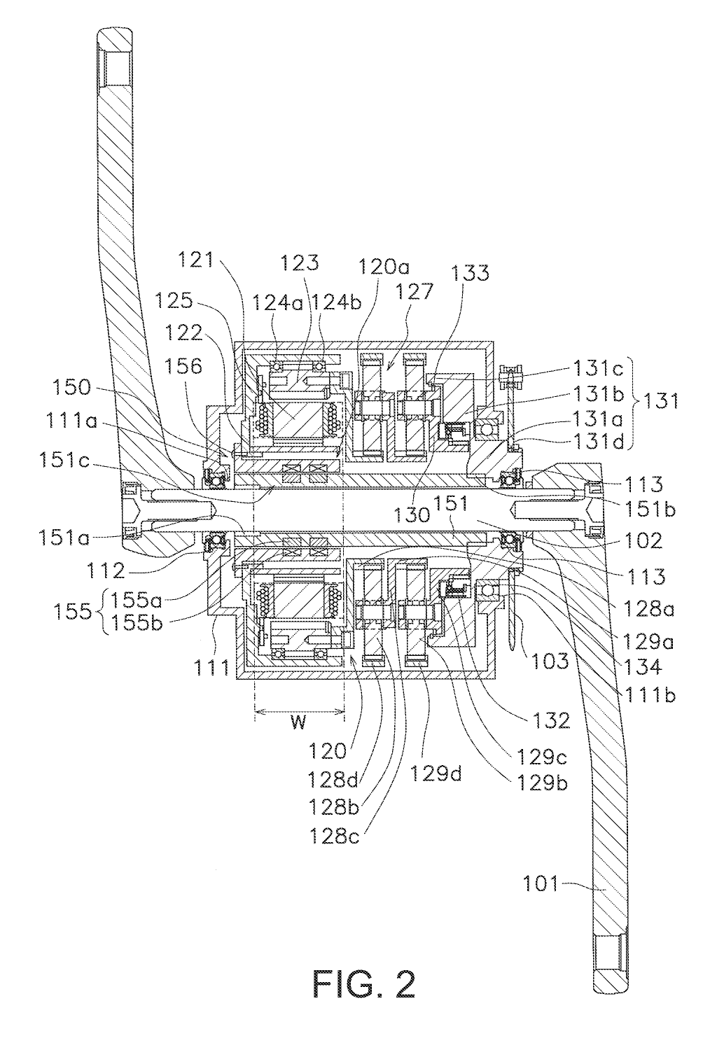

According to the first embodiment, the drive unit 1 has a configuration that the rotational axis of the crank axle 102 and the rotational axis of the motor 120 are coaxially arranged with each other. In the following, the structure and function of the drive unit 1 will be explained. As can be seen from FIG. 2, the drive unit 1 has a casing 111 that houses the motor 120. The motor 120 has a hole 120a that receives the crank axle 102 therethrough. A crank axle torsion sensor unit 150 is arranged at least partially in between the motor 120 and the crank axle 102 inside of the crank axle receiving hole 120a. Hereinafter, the crank axle torsion sensor unit 150 shall be simply referred to as “the sensor unit 150”.

As shown in FIG. 2, the crank axle 102 is inserted in the through hole 111a of the casing 111. The crank axle 102 is supported via the bearings 112 and 113 on the casing 111 to be capable of rotating. On the opposite ends of the crank axle 102, the crank arms 101 are detachably attached. The crank arms 101 are arranged outside of the casing 111. One crank arm 101 among the two crank arms 101 can also be configured to be not detachable from the crank axle 102.

The motor (electric motor) 120 has a crank axle receiving hole 120a that allows the crank axle 102 to be arranged thereon. The crank axle receiving hole 120a is arranged at the rotating central portion of the motor 120. The motor 120 is arranged so that its rotational axis is coaxial with the rotational axis of the crank axle 102. The stator 121 of the motor 120 is formed in a cylindrical shape. The excitation coil is wound and arranged concentric to the crank axle 102, and the excitation coil is anchored by a mounting section 122 on the motor case 125. The motor case 125 is anchored on the casing 111. The crank axle receiving hole 120a is formed on the inner side in the radial direction of the stator 121. The rotor 123 is formed in a cylindrical shape. The rotor 123 is supported in a freely rotatable on the motor case 125. The rotor 123 has a magnet (not shown in the figure) having plural magnetic poles in the circumferential direction and a magnet holding section (not shown in the drawings) for holding the magnet. The motor in the present embodiment is an outer rotor-type motor that has the rotor 123 arranged on the outer side of the stator 121. The rotor 123 is rotatably supported by a first bearing 124a and a second bearing 124b arranged with an interval in the crack axial direction so that the rotor can rotate freely around the crank axle 102. The first bearing 124a and the second bearing 124b are supported on the motor case 125. Here, the motor 120 is driven by an inverter not shown in the figure. The inverter is driven by a control section not shown in the figure, and the control section controls the inverter according to the pedaling force and the speed of the bicycle.

The sensor unit 150 detects the torsion applied on the crank axle 102. This torsion is proportional to the pedaling force applied by the user on the crank axle 102. By detecting the torsion, the pedaling force of the user applied on the crank axle 102 can be determined. The sensor unit 150 has a hollow or tubular member 151 and a strain sensor 155. The hollow member 151 includes an inserting hole for arranging the crank axle 102, and a strain sensor 155. The hollow member 151 has a first connecting part 151a, a second connecting part 151b, and an inserting hole 151.c. The first connecting part 151a is connected to the crank axle 102. The second connecting part 151b transmits the rotating force to the power transmission unit to be explained later. The inserting hole 151.c can have the crank axle 102 arranged in the inserting hole. Except for the first connecting part 151a, the hollow member 151 is arranged with a space from the crank axle 102. With the first connecting part 151a, the hollow member 151 is inserted on the key or the serration protruding from the crank axle 102, and the hollow member is anchored by screwing or press-in or other means. The first connecting part 151a and the second connecting part 151b are arranged with a space between each other in the direction of the crank axle 102. The strain sensor 155 is a magnetostrictive sensor, and the strain sensor has a magnetostrictive element 155a arranged in the hollow member 151 and a detecting coil 155b arranged on the periphery of the magnetostrictive element 155a. The detecting coil 155b is anchored by a mounting member 156 on the motor case 125. As a result, the detecting coil 155b is supported not to be rotatable in casing 111.

A portion of the sensor unit 150 is at least partially arranged in between the motor 120 and the crank axle 102. According to the present embodiment, the portion between the motor 120 and the crank axle 102 is the range W between the two ends of the stator 121 in the direction of the extension of the rotational axis of the motor 120 and is a region until the crank axle 102. Among the sensor unit 150, at least a portion or the entirety of the strain sensor 155 is preferred to be arranged between the two ends of the stator 121 and in the region until the crank axle 102 in the direction of the extension of the rotational axis of the motor 120. At least a portion or the entirety of the strain sensor 155 may also be arranged in the range W between the two ends of the stator 121 in the direction of the extension of the rotational axis of the motor 120, in the range where the rotor 123 overlaps in the direction of the extension of the rotational axis of the motor 120, and in the region until the crank axle 102.

The reduction gear unit 127 transmits the rotation of the rotor 123 to the torque transmission member 130. The reduction gear unit 127 has one or more gears. In the example shown in FIG. 2, the reduction gear unit 127 has 2 planetary gear units. The first planetary gear unit has a first sun gear section 128a connected to the rotor 123, plural first planetary gears 128b, a first carrier section 128c that supports the plural first planetary gears 128b in a rotatable way, and a first ring gear section 128d anchored on the casing 111. The second planetary gear unit has a second sun gear section 129a, plural second planetary gears 129b, a second carrier section 129c that supports the plural second planetary gears 129b in a rotatable way, and a second ring gear section 129d anchored on the casing 111.

The output of the reduction gear unit 127 is transmitted via the torque transmission member 130 to the power transmission unit 131 (to be explained in detail later). The torque transmission member 130 is supported in a rotatable way via the one-way clutch 132 and the rotating supporting member 133 on the inner side surface of the power transmission unit 131 (to be explained in detail later). The rotating supporting member 133 is made of a slide bearing in this embodiment. However, the rotating supporting member may also be made of a rolling bearing. The rotating supporting member 133 is arranged on the outer side in the radial direction from the one-way clutch 132 with respect to the crank axle. The torque transmission member 130 supports the plural clutch hooks of the one-way clutch 132.

The power transmission unit 131 transmits the rotating force of the motor 120 and the rotating force of the crank axle 102 to the front sprocket 103. The power transmission unit 131 is arranged on the end portion side of the crank axle 102. The power transmission unit 131 is formed in annular shape, and the power transmission unit has the first annular portion 131a, the second annular portion 131b, and the third annular portion 131c. Here, the first annular portion 131a extends along the crank axle 102. The second annular portion 131b extends in the radial direction with respect to the crank axle 102 from the end portion of the first annular portion 131a on the motor 120 side. The annular portion 131c extends in the direction parallel with the crank axle 102 from the motor side end portion of the second annular portion 131b. The inner peripheral portion of the power transmission unit 131 is connected via the one-way clutch 132 to the torque transmission member 130. On the inner peripheral portion of the second annular portion 131b, the clutch groove of the one-way clutch 132 is formed. On the inner peripheral portion of the third annular portion 131c, the rotating supporting member 133 is arranged. The rotating supporting member 133 supports the rotation of the torque transmission member 130. On the inner peripheral portion of the first annular portion 131a, a bearing 113 is arranged. On the outer peripheral portion of the first annular portion 131.a, a bearing 134 is arranged. As a result, the power transmission unit 131 is supported by the casing 111 in a reliable way. The bearings 113 and 134 are formed as, for example, radial bearings. The inner ring of the bearing 113 supports the crank axle 102, and the outer ring of the bearing 134 is supported by the casing 111. The end portion of the power transmission unit 131 (the end portion of the first annular portion) protrudes out from the opening 111b of the casing 111. The power transmission unit 131 has a sprocket connecting part 131d on the outer peripheral portion of the portion of the first annular portion 131a protruding out from the casing 111. On the sprocket connecting part 131d, the front sprocket 103 is detachably attached by, for example, a bolt. As a result, the front sprocket 103 can rotate integrally with the power transmission unit 131. The power transmission unit 131 has the first annular portion 131.a fixed with the second connecting part 151b of the hollow member 151. In this way, the power transmission unit 131 rotates integrally with the crank axle 102. The power transmission unit 131 may be detachably attached on the second connecting part 151b by, for example, serration.

In the following, the effects of the first embodiment will be explained. For the drive unit in the first embodiment, the rotational axis of the crank axle 102 and the rotational axis of the motor 120 are arranged coaxial with each other, and at least a portion of the sensor unit 150 is arranged in the hole 1320a of the motor 120 where the crank axle 102 is arranged. As a result, the drive unit 1 in the first embodiment has the transmission mechanism, and the drive unit 1 shares the motor 120 for assisted riding of the bicycle, and the drive unit 1 is lighter and more compact.

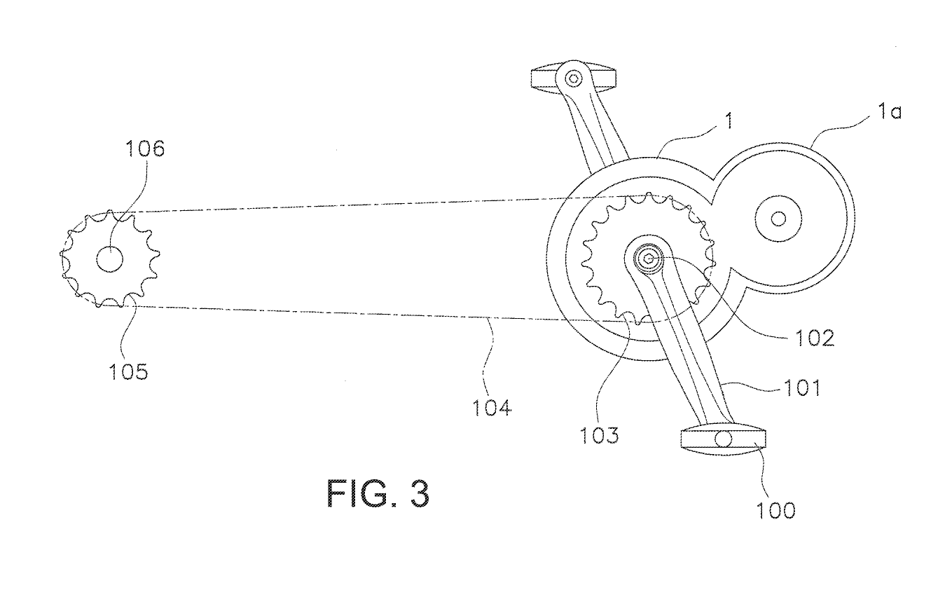

FIG. 3 is a right side view illustrating an example of a drive train of the electrically assisted bicycle having a drive unit according to a second embodiment and a third embodiment to be explained later. As shown in FIG. 3, the configuration other than a portion 1a related to the transmission mechanism of the drive unit 1 is the same as the drive unit 1 in the first embodiment.

For the drive unit 1 according to this embodiment, the rotational axis of the crank axle and the rotational axis of the motor are formed coaxial to each other, and the rotational axis of the transmission mechanism is formed different from the rotational axis of the crank axle and the motor. This is the characteristic feature of this embodiment. In the following, the structure and function of the drive unit 1 will be explained.

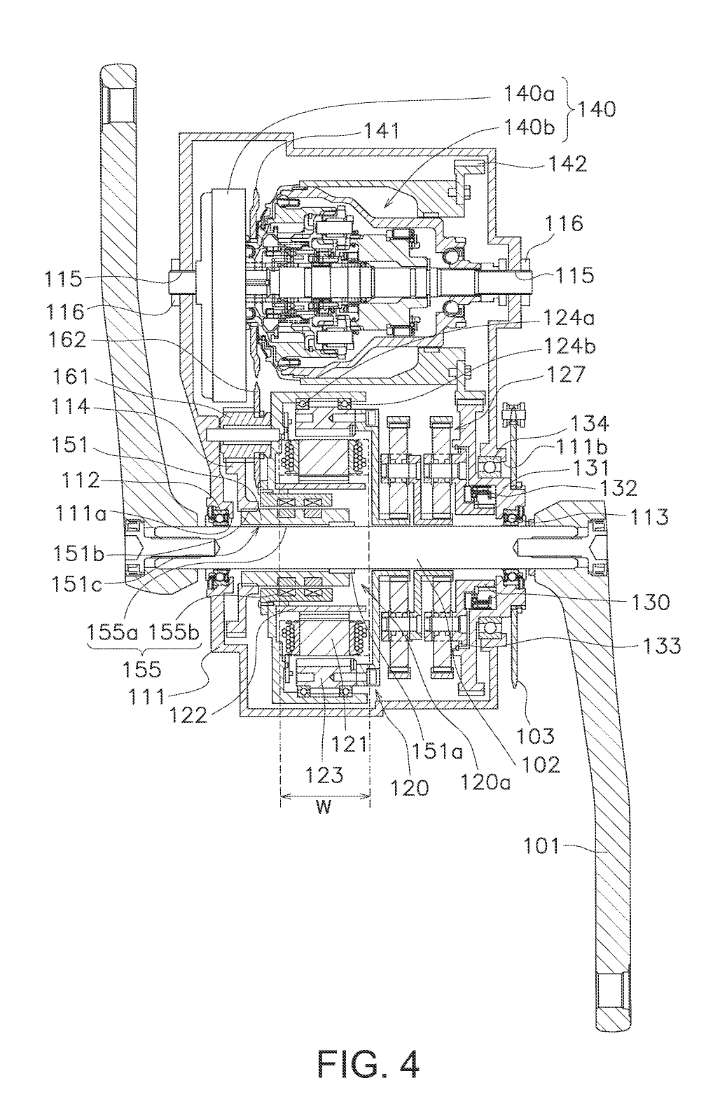

FIG. 4 is a cross-sectional view illustrating the drive unit 1 according to the second embodiment of the present invention. The drive unit 1 according to the second embodiment differs from the drive unit 1 according to the first embodiment in the following features. The rotating force related to the second connecting part 151b of the sensor unit 150 is transmitted to the transmission mechanism 140 via the first gear 114, the second gear 161, the first internal sprocket 162, and the second internal sprocket 141. Here, the output of the transmission mechanism 140 is transmitted via the third gear 142 to the power transmission unit 131. Otherwise, this embodiment is the same as the first embodiment. Consequently, in the following, only the features different from the first embodiment will be explained in detail.

The second connecting part 151b of the sensor unit 150 is connected to the first gear 114. The first gear 114 is arranged on the end portion on the side opposite to the end portion of the crank axle 102 in the power transmission unit 131. At the same time, the first connecting part 151a of the sensor unit 150 is arranged on the power transmission unit 131 side. The first connecting part 151a is connected to the crank axle 102 in the region between the motor 120 and the crank axle 102. The first gear 114 is fixed on the second connecting part 151b, and the first gear is integrally rotated together with the crank axle 102. The first gear 114 may be detachably attached on the second connecting part 151b by, for example, serration. The hollow member 151, except for the first connecting part 151a, is arranged with a space from the crank axle 102 arranged on the inner side. According to this embodiment, too, a portion of the sensor unit 150 is at least partially arranged between the motor 120 and the crank axle 102. At least a portion or the entirety of the strain sensor 155 is arranged in the extending direction of the rotational axis of the motor 120 in the region W between the two ends of the stator 121 and in the region until the crank axle 102.

The second gear 161 and the first internal sprocket 162 are fixed with each other, and they integrally rotate. The second gear 161 is engaged with the first gear 114. The first internal sprocket 162 transmits the rotating force via the chain or the belt or other transmission member not shown in the figure to the second internal sprocket. The second internal sprocket 141 is a member for inputting the torque to the transmission mechanism 140. The connecting mechanism is arranged on the side opposite to the power transmission unit 131 and the front sprocket 103 with the motor 120 sandwiched between the power transmission unit and the front sprocket.

The transmission mechanism 140 has a motor unit 140a for the transmission mechanism and a transmission mechanism main body 140b. Under the instruction of the rider on the transmission operation section (not shown in the figure) installed on the handle, the motor unit 140a for the transmission mechanism has the locking member of the transmission mechanism main body 140b rotated to the prescribed phase. For example, the motor unit 140a for the transmission mechanism may be the well-known motor unit disclosed in Japanese Patent No. 3529723. The transmission mechanism main body 140b is a transmission unit that allows the selection from among the plural gear ratios. For example, the transmission mechanism main body 140b may be the well-known transmission unit disclosed in the Japanese Utility Model Registration No. 3146138. On the outer peripheral portion of the transmission mechanism main body 140b, the third gear 142 is installed so that the third gear cannot rotate. The third gear 142 can integrally rotate with the cylindrical-shaped member with a stepwise increased diameter arranged on the outer peripheral portion of the transmission mechanism main body 140b.

In the following, the operation of this drive unit will be explained. The torque due to the pedaling force of the rider is transmitted via the transmission mechanism through the following route: the crank anus 101→the crank axle 102→the first connecting part 151a→the second connecting part 151b→the first gear 114→the second gear 161→the first internal sprocket 162→the second internal sprocket 141→the transmission mechanism main body 140b→the third gear 142→the power transmission unit 131. On the other hand, the output torque from the motor is transmitted through the following route: the reduction gear unit 127→the torque transmission member 130→the one-way clutch 132→the power transmission unit 131. The power transmission unit 131 combines these two torques into a combined torque. The power transmission unit 131 transmits the combined torque to the front sprocket 103. As a result, assisting by the motor is realized.

In the following, the effects of the second embodiment will be explained. In addition to the effects of the first embodiment, the drive unit of the present embodiment also can realize the following effects. As the input torque of the transmission mechanism, the output torque of the motor is not applied. Consequently, even for the transmission mechanism having the same planetary gear mechanism as that of the internal transmission mechanism, the rider still can smoothly carry out gear change for the transmission section. Also, as plural gear ratios can be selected by the transmission mechanism, the assisting driving by the motor at a high efficiency can be carried out.

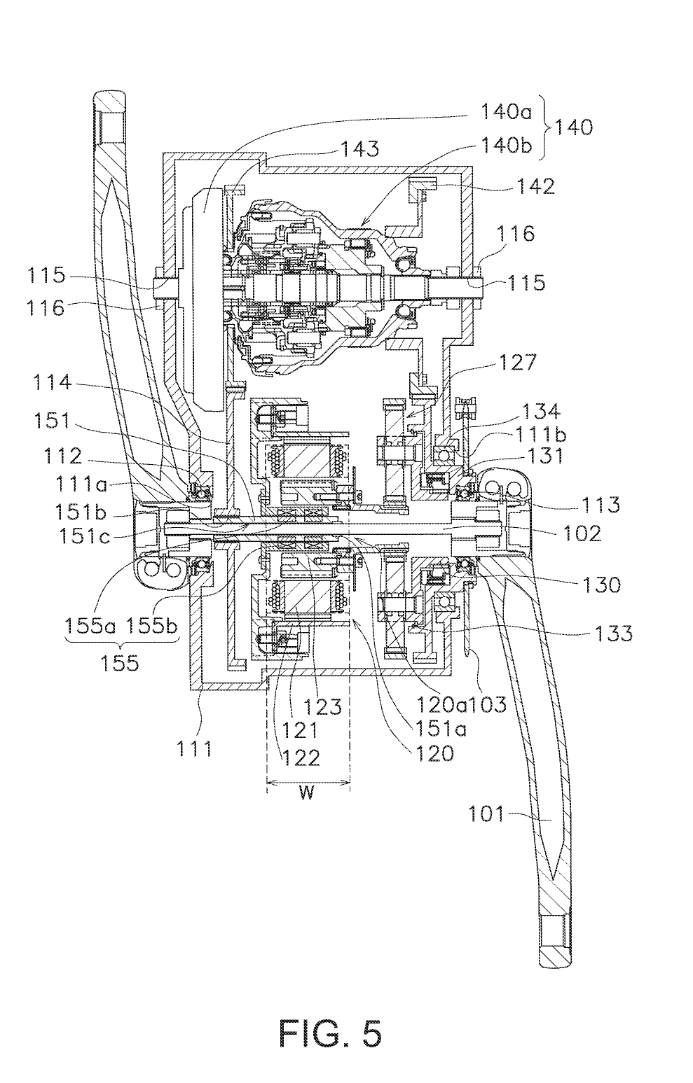

FIG. 5 is a cross-sectional view illustrating the drive unit according to the third embodiment of the present invention. The drive unit according to the third embodiment differs from the drive unit according to the second embodiment mainly in the following points. The motor 120 is an inner rotor-type motor wherein the rotor 123 is arranged inside of the stator 121. In the following, only the features different from those of the first embodiment will be explained in detail. Here, FIG. 5 illustrates an example of the case where there is only one gear in the reduction gear unit 127. However, this is merely an example. The functions of the reduction gear unit 127 are the same as those of the first embodiment and the second embodiment.

The second connecting part 151b of the sensor unit 150 is connected to the first gear 114. The first gear 114 is fixed on the second connecting part 151b, and the first gear integrally rotates together with the crank axle 102. The first gear 114 may also be detachably attached on the second connecting part 151.b by, for example, serration. The first connecting part 151a is connected to the crank axle 102 in the region between the motor 120 and the crank axle 102. Except for the first connecting part 151a, the hollow member 151 is arranged with a space from the crank axle 102 arranged on the inner side.

The fourth gear 143 is engaged with the first gear 114. The fourth gear 143 is a member that inputs the torque to the transmission mechanism 140. The connecting mechanism is arranged on the side opposite to the power transmission unit 131 and the front sprocket 103 with the motor 120 sandwiched between them. According to the present embodiment, a portion of the sensor unit 150 is at least partially arranged in between the motor 120 and the crank axle 102, and at least a portion or the entirety of the strain sensor 155 is arranged in the direction of the extension of the rotational axis of the motor 120 in the region W between the two ends of the stator 121 and in the region until the crank axle 102.

In the following, the operation of this drive unit will be explained. The torque generated from the pedaling force of the rider is transmitted via the transmission mechanism in the following route: the crank arms 101→the crank axle 102→the first connecting part 151a→the second connecting part 151b→the first gear 114→the fourth gear 143→the transmission mechanism main body 140b→the third gear 142→the power transmission unit 131. On the other hand, the output torque from the motor is transmitted through the following route: the reduction gear unit 127→the torque transmission member 130→the one-way clutch 132→the power transmission unit 131. The power transmission unit 131 combines these two torques and transmits the combined torque to the front sprocket 103. As a result, assisting by the motor is realized.

In the following, the effects of the third embodiment will be explained. Although the motor is of the inner rotor type, the drive unit of the present embodiment stilt can display the same effects as those of the second embodiment.

In the third embodiment, the case when the transmission mechanism 140 is contained is presented as an example. However, in the third embodiment, one may also adopt a scheme in which the transmission mechanism 140 is not contained as the sensor unit 150 and the power transmission unit 131 of the first embodiment.

In the above embodiments, the strain sensor 155 is presented as a magnetostrictive element. However, this is merely an example. The strain sensor may also be a strain gauge or a semiconductor sensor. In addition, in the example presented above, the magnetostrictive element 155a is arranged in the hollow member 151. However, the magnetostrictive element 155a may also be directly arranged on the crank axle 102.

In the illustrated embodiments, an example of two types of the connecting mechanism has been presented. However, one can also adopt a scheme in which three or more gears are in use to transmit the drive force from the crank axle 102 to the transmission mechanism 140. Also, several gears may be arranged between the output section of the transmission mechanism and the power transmission unit 131 to transmit the drive force.

In addition, the transmission mechanism main body 140b may be a stepless transmission unit instead of the stepped transmission unit. The motor 120 may also be either a brush motor or a brushless motor. If the motor 120 can work at a low speed, the reduction gear unit 127 can be omitted. In this case, the output of the motor is transmitted as the output of the motor is to the one-way clutch 132.

In the second embodiment and the third embodiment, the transmission operation is carried out manually. However, an automatic transmission can also be adopted. In this case, a speed sensor for detecting the speed of the bicycle is arranged; on the basis of the output of the speed sensor and the output from the torque detecting means, the control section controls the motor unit 140a for the transmission mechanism to carry out the operation of the transmission mechanism 140.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. Finally, terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, components that are shown directly connected or contacting each other can have intermediate structures disposed between them unless specifically stated otherwise. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle drive unit comprising:
a motor having a crank axle receiving hole arranged for installing a crank axle; and
a crank axle torsion sensor unit at least partially disposed inside of the crank axle receiving hole in between the motor and the crank axle.

2. The bicycle drive unit according to claim 1, wherein
the hole is arranged at a rotating center portion of the motor.

3. The bicycle drive unit according to claim 2, wherein
the crank axle has a rotational axis that is coaxially arranged with a rotational axis of the motor.

4. The bicycle drive unit according to claim 1, further comprising
a power transmission unit operatively connected to the motor and the crank axle to transmit a rotating force of the motor and a rotating force of the crank axle as a combined output torque.

5. The bicycle drive unit according to claim 4, further comprising
a transmission mechanism having a plurality of gear ratios disposed in a transmission path between the crank axle and the power transmission unit.

6. The bicycle drive unit according to claim 4, wherein
the crank axle torsion sensor unit includes
a first connecting part connected to the crank axle; and
a sprocket connecting part that transmits the rotating force to the power transmission unit, the sprocket connecting part is spaced apart from the first connecting part in an axial direction of the crank axle.

7. The bicycle drive unit according to claim 6, wherein
the crank axle torsion sensor unit further includes
a tubular member, which includes the first connecting part and the sprocket connecting part, the tubular member having an inserting hole for receiving the crank axle, and
a strain sensor that detects the strain of the tubular member.

8. The bicycle drive unit according to claim 7, wherein
the strain sensor includes a magnetostrictive sensor.

9. The bicycle drive unit according to claim 8, wherein
the magnetostrictive sensor includes a magnetostrictive element arranged in the tubular member, and a coil arranged surrounding the magnetostrictive element.

10. The bicycle drive unit according to claim 1, further comprising
the crank axle.

11. The bicycle drive unit according to claim 4, wherein
the power transmission unit has a sprocket connecting part configured to connect a sprocket thereto.

12. The bicycle drive unit according to claim 4, further comprising
a one-way clutch transmitting a rotating force of the motor to the power transmission unit.

13. The bicycle drive unit according to claim 4, further comprising
a reduction gear unit transmitting a rotating force of the motor to the power transmission unit.

14. The bicycle drive unit according to claim 4, further comprising
a reduction gear unit operatively coupled to the motor and receives a rotating force of the motor; and
a one-way clutch transmitting an output of the reduction gear unit to the power transmission unit.

15. The bicycle drive unit according to claim 1, wherein
the motor is an outer rotor-type motor.

16. The bicycle drive unit according to claim 1, wherein
the motor is an inner rotor-type motor.
